(19) United States
(12) Patent Application Publication
(10) Pub. No.: US 2023/0174374 A1
(43) Pub. Date: Jun. 8, 2023

(54) PROCESS FOR IMPROVING THE QUALITY OF HYDROGEN-BEARING ORGANIC LIQUIDS

(71) Applicant: ARKEMA FRANCE, Colombes (FR)

(72) Inventors: Jérôme BLANC, PIERRE-BENITE Cedex (FR); Bernard MONGUILLON, COLOMBES CEDEX (FR)

(21) Appl. No.: 17/998,938

(22) PCT Filed: Jul. 8, 2021
(86) PCT No.: PCT/FR2021/051268

§ 371 Date: Nov. 16, 2022

(30) Foreign Application Priority Data
Jul. 10, 2020 (FR) FR2007313

(51) Int. Cl. C01B 3/00; B01J 20/12; B01J 20/18; B01D 15/08

(52) U.S. Cl. CPC C01B 3/0015; B01J 20/12; B01J 20/18; B01D 15/08

(57) ABSTRACT

The present invention relates to a process for producing hydrogen from a liquid capable of being used in at least one hydrogenation/dehydrogenation cycle, said process comprising at least one step wherein said liquid is brought into contact with a filtering agent. The invention also relates to the use of a filtering agent for the purification of a liquid capable of being used in at least one hydrogenation/dehydrogenation cycle, in a hydrogen production process.

The present invention relates to the field of aromatic molecules capable of transporting hydrogen, and more particularly the field of the purification of said aromatic molecules capable of transporting hydrogen.

The use of aromatic molecules has been the subject of numerous studies over the past decade in the field of hydrogen transport and storage (referred to as LOHC (Liquid Organic Hydrogen Carrier) technology).

The principle consists in fixing hydrogen on a carrier molecule, which is preferably and most often liquid at ambient temperature, in a hydrogenation step, then in releasing the fixed hydrogen, close to the site of consumption, in a dehydrogenation step.

Among the molecules most studied today, aromatic fluids with two or three rings, such as for example benzyltoluene (BT) and/or dibenzyltoluene (DBT) which have already been the subject of numerous studies and patent applications, represent molecules particularly suitable for this use. Patent EP 2 925 669 thus demonstrates the use of BT and DBT in LOHC technology, and describes the hydrogenation and dehydrogenation operations of these fluids for hydrogen storage and release.

As well as the immediate performance of the hydrogenation and dehydrogenation steps, the sequencing of the cycles and the maintaining of the performance levels (hydrogen fixation/release yield) and also the quality of the hydrogen obtained during the dehydrogenation step are key points as regards the economic aspect of this technology.

Indeed, the hydrogen resulting from this LOHC technology finds uses in very many fields, such as for example in fuel cells, in industrial processes, or else as fuel for means of transport (trains, boats, trucks, motor cars). Any impurity present in the hydrogen, even in trace amounts, could have a negative impact both on the hydrogenation/dehydrogenation process in terms of yield, and on the quality of the products manufactured or else on the yields in the end uses of the hydrogen produced by this technique.

In order to overcome these potential problems, one of the solutions is for the hydrogen recovered during the dehydrogenation step to be as pure as possible. However, the hydrogen produced during the dehydrogenation step inevitably entrains with it impurities resulting from organic compounds often present in the organic liquid to be dehydrogenated.

These impurities are of various natures, and may be present in large or smaller amounts. One class of impurities in particular consists of the oxygenated derivatives present in the fluid which undergoes the hydrogenation/dehydrogenation cycles (referred to as “LOHC fluid” in the rest of the present description), either inherently (due to the process for manufacturing said LOHC fluid), or formed by the presence of dissolved oxygen mainly during the steps of handling the LOHC fluid, the transport thereof, or else the transfer thereof. This dissolved oxygen, under the hydrogenation and dehydrogenation conditions, can, depending on the operating conditions (temperature, pressure, catalyst) react with the LOHC fluid to form oxygenated derivatives.

Thus, one group of impurities that may be present in the LOHC fluid, and which may be present and/or co-produced with the hydrogen during the dehydrogenation step, comprises gaseous species such as oxygen derivatives, mainly oxides, and more particularly carbon oxides (COx), nitrogen oxides (NOx) and sulfur oxides (SOx), and the like, and also mixtures thereof.

Besides the fact that these impurities, mainly in the form of oxides as indicated above, can contaminate the hydrogen produced from the dehydrogenation of the LOHC liquid, it is also possible for a greater or lesser portion of these impurities to remain in the LOHC fluid, with a risk of accumulation of the impurities in the LOHC fluid after numerous hydrogenation/dehydrogenation cycles.

It therefore appears necessary to remove the impurities present in the LOHC fluids which are subjected to numerous hydrogenation/dehydrogenation cycles. The removal of impurities should advantageously be carried out one or more times before the dehydrogenation/hydrogenation steps in order to prevent contamination of the hydrogen produced and the accumulation of the impurities in the LOHC fluid after several dehydrogenation/hydrogenation cycles.

Thus a first objective of the present invention is the production of pure hydrogen by dehydrogenation of a fluid. Another objective is the production of hydrogen comprising a content of impurities that is as low as possible, by dehydrogenation of a fluid. Another objective is to provide a fluid capable of being dehydrogenated in order to supply hydrogen comprising a content of impurities that is as low as possible, it being possible for said fluid to be reused in a large number of hydrogenation/dehydrogenation cycles. Yet another objective is to improve the production of hydrogen by dehydrogenation of fluids, in terms of purity, yield, and manufacturing costs, among others.

It has surprisingly been discovered that the abovementioned objectives are solved, entirely or at least in part, by virtue of the present invention. Yet other objects may become apparent in the description of the present invention that follows.

Indeed, the inventors have now discovered that the production of hydrogen of improved purity can in particular be achieved by improving the quality of the fluid capable of being dehydrogenated, then hydrogenated again, that is to say by improving the quality of a fluid involved in numerous dehydrogenation/hydrogenation cycles.

Thus, and according to a first aspect, the invention relates to a process for producing hydrogen from a liquid capable of being used in at least one hydrogenation/dehydrogenation cycle, said process comprising at least one step wherein said liquid is brought into contact with a filtering agent.

It has in fact been discovered, quite surprisingly, that the treatment of an LOHC liquid, for example an aromatic liquid, optionally at least partially or completely hydrogenated, can be purified, and in particular the content of oxygenated organic impurities can be significantly reduced, by bringing said LOHC liquid into contact with a filtering agent.

The filtering agents which can be used in the context of the present invention can be of any type and are well known to those skilled in the art. The filtering agents which have proved to be the most suitable are adsorbent filtering agents, and more particularly filtering agents comprising one or more compounds chosen from minerals based on silicates, carbonates, coal, and also mixtures of two or more of these minerals in any proportions.

Mention may be made, as nonlimiting examples, of mineral or organic filtering agents, and in particular those chosen from clays, zeolites, diatomaceous earths, ceramics, carbonates, and coal derivatives, and also mixtures of two or more of them, in any proportions.

mention may more particularly be made, as filtering agents, of the following:
clays, including silicates, and for example magnesium silicates, such as and without limitation, attapulgites, montmorillonites, selenites, bentonites, talcs, and the like,
natural or synthetic aluminum silicates, in particular kaolins, kaolinites, zeolites,
carbonates, for example calcium and/or magnesium carbonates, and more particularly those known under the names limestone or chalks,
derivatives of coal, wood, shells, for example coconut shells, olive pits or husks, and more generally those known under the name of activated carbons,
and the like and mixtures thereof.

Silicates, in particular clays and zeolites, have proved to be very particularly effective for the requirements of the process according to the present invention. Silicates have in fact proved to be very particularly suitable for the removal, or at the very least for the significant reduction, of the impurities present in a liquid capable of being used in at least one hydrogenation/dehydrogenation cycle for the production of hydrogen.

According to a very particularly preferred embodiment of the present invention, as examples of filtering agents that can be used in the context of the hydrogen production process according to the invention, mention may be made of the attapulgite Microsorb® 16/30 LVM from BASF (example of magnesium-aluminum clay with the chemical formula (Mg, Al)₅Si₈O₂₂(OH)₄, SiO₂), Amcol Rafinol 900 FF from Minerals Technologies, Amcol Rafinol 920 FF from Minerals Technologies, Amcol Mineral Bent (aluminum hydrosilicate) from Minerals Technologies, and Siliporite®, in particular MK30B0 and MK30B2, from ARKEMA (preparations based on aluminosilicate zeolite).

The liquid capable of being hydrogenated/dehydrogenated and which is brought into contact with a filtering agent can be any type of liquid, optionally at least partially hydrogenated, or even completely hydrogenated, and preferably at least partially hydrogenated, or even completely hydrogenated, and is usually an LOHC fluid, as defined previously. LOHC fluids which are liquid at ambient temperature and pressure (25° C., 1 atmosphere) are preferred, for obvious reasons of ease of handling and transport.

Preferably, the LOHC fluid, in its completely dehydrogenated form, is a fluid comprising at least one aromatic ring, and for example the LOHC fluid may be derived from petroleum products and/or products synthesized from petroleum products. As a variant, the LOHC fluid, and which comprises at least one aromatic ring, in its completely dehydrogenated form, may be derived from renewable products and/or from products synthesized from renewable products.

It should be understood that the fluid of the present invention may comprise one or more fluids, in the form of mixtures and for example a mixture comprising one or more fluids derived from petroleum products and one or more fluids derived from renewable products.

Fluids derived from petroleum products is understood to mean, for the purposes of the present invention, the products derived from the separation and/or purification of petroleum, but also the compounds derived from the synthesis of compounds bearing aromatic ring(s) of petroleum origin. Fluids derived from renewable products is understood to mean, for the purposes of the present invention, the products derived from biomass, and in particular derived from the extraction of wood (for example lignin) and resinous products, and also the compounds derived from syntheses of renewable products.

According to a preferred embodiment, the fluid, referred to as LOHC fluid, which can be used in the process of the present invention corresponds to the general formula (1):

(A-X)ₙ-B (1)

wherein:
A and B, which are identical or different, represent, independently of one another, an aromatic ring, optionally completely or partially hydrogenated, optionally comprising at least, and preferably, one heteroatom, and optionally substituted by one or more saturated or partially or completely unsaturated hydrocarbon radicals comprising from 1 to 20 carbon atoms, preferably from 1 to 18 carbon atoms, more preferably from 1 to 12 carbon atoms, better still from 1 to 10 carbon atoms, even better still from 1 to 6 carbon atoms, typically from 1 to 3 carbon atoms,
X represents a spacer group, chosen from a single bond, an oxygen atom, a sulfur atom, the divalent radical —(CRR′)ₘ—, the divalent radical >C═CRR′, and the divalent radical —NR″—, or else
when n is other than 0 (zero), X forms, with the aromatic rings to which it is attached, a saturated or unsaturated ring comprising from 4 to 10 ring members, among which one or more of them may be a heteroatom chosen from oxygen, nitrogen, sulfur, it being possible for said saturated or unsaturated ring to further be substituted by one or more hydrocarbon chains comprising from 1 to 30 carbon atoms, preferably from 1 to 10 carbon atoms,
R and R′, which are identical or different, are selected, independently of one another, from hydrogen and a saturated or partially or completely unsaturated hydrocarbon radical comprising from 1 to 6 carbon atoms, preferably from 1 to 3 carbon atoms,
R″ represents a saturated or partially or completely unsaturated hydrocarbon radical comprising from 1 to 6 carbon atoms, preferably from 1 to 3 carbon atoms,
m represents an integer of between 1 and 4, endpoints included, and
n can be equal to 0 or represents an integer equal to 1, 2 or 3, preferably equal to 1 or 2, with the restriction that, when n is equal to 0, B is substituted by one or more hydrocarbon radicals, as defined above.

The term “aromatic ring” is understood to mean monocyclic aromatic hydrocarbons and polycyclic aromatic hydrocarbons, comprising from 6 to 20 carbon atoms, among which one or more of them may be heteroatoms chosen from oxygen, sulfur and nitrogen, preferably from sulfur and nitrogen, and more preferably nitrogen. A “polycyclic compound” is understood to mean the rings defined above, which are fused or condensed, for example two, or more preferably two or three or four, more preferably two or three, for example two, fused or condensed rings.

When n is equal to 0, the LOHC fluid of formula (1) defined above forms part of the family of alkylbenzenes, which are optionally partially or completely hydrogenated. When n is equal to 2 or 3, the groups (AX) may be identical or different.

According to one preferred embodiment of the present invention, in the LOHC fluid of general formula (1), n is other than 0 and B is substituted by a hydrocarbon radical. Preferably again, said hydrocarbon radical is an alkyl radical comprising from 1 to 6 carbon atoms, preferably from 1 to 4 carbon atoms, and preferably the alkyl radical is the methyl radical.

According to another preferred embodiment of the present invention, in the LOHC fluid of general formula (1), n is equal to 0 and the organic liquid of formula (1) is generally chosen from linear alkylbenzenes, which are optionally completely or partially hydrogenated, and branched alkylbenzenes, which are optionally completely or partially hydrogenated, such as, for example and without limitation, alkylbenzenes, and homologs which are optionally completely or partially hydrogenated, in which the alkyl part comprises from 10 to 20 carbon atoms.

Such alkylbenzenes include, again without limitation, decylbenzene, dodecylbenzene, octadecylbenzene, and the optionally completely or partially hydrogenated homologs thereof, to mention only a few of them.

As indicated earlier, the LOHC fluids corresponding to the general formula (1) above can be used, alone or as mixtures of two or more of them in any proportions. According to one preferred embodiment of the invention, the LOHC fluid employed in the process of the present invention may contain one compound bearing at least one aromatic radical, which is optionally completely or partially hydrogenated, or a mixture of two or more compounds bearing at least one aromatic radical, which is optionally completely or partially hydrogenated. According to one very particularly preferred embodiment, and as indicated previously, the LOHC fluid employed in the process of the invention is liquid at ambient temperature and ambient pressure.

According to yet another preferred embodiment of the present invention, the LOHC fluid is chosen from benzyltoluene (BT), dibenzyltoluene (DBT), the partially or completely hydrogenated homologs thereof, and also mixtures thereof in any proportions.

In a very particularly preferred embodiment, the LOHC fluid is chosen from the organic fluids sold by Arkema under the trade names of the Jarytherm® range.

Other LOHC fluids, and partially or completely hydrogenated homologs thereof, suitable for the requirements of the present invention are, for example, those sold by Eastman, especially under the trade name Marlotherm®.

Mention may be made, as yet other examples of LOHC fluids suitable for the requirements of the present invention, of:

diphenylethane (DPE) and isomers thereof, in particular 1,1-DPE (CAS 612-00-0), 1,2-DPE (CAS 103-29-7) and mixtures thereof (notably CAS 38888-98-1); such organic liquids being available commercially or described in the literature, for example in document EP 0 098 677,
ditolyl ether (DT) and isomers thereof, in particular those corresponding to the numbers CAS 4731-34-4 and CAS 28299-41-4 and mixtures thereof, these notably being commercially available from Lanxess, under the trade name Diphyl DT,
phenylxylylethane (PXE) and isomers thereof, in particular those corresponding to the numbers CAS 6196-95-8 and CAS 76090-67-0 and mixtures thereof, notably commercially available from Changzhou Winschem, under the trade name PXE Oil,
monoxylylxylenes and dixylylxylenes, isomers thereof and mixtures thereof (CAS 186466-85-3),
1,2,3,4-tetrahydro-(1-phenylethyl)naphthalene (CAS 63674-30-6), this product being commercially available in particular from Dow under the reference Dowtherm™ RP,
diisopropylnaphthalene (CAS 38640-62-9), notably available from Indus Chemie Ltd under the trade name KMC 113,
monoisopropylbiphenyl and isomers thereof (CAS 25640-78-2), notably available under the trade name Wemcol,
phenylethylphenylethane (PEPE) and isomers thereof (CAS 6196-94-7), notably available from Changzhou Winschem or Yantai Jinzheng,
N-ethylcarbazole, notably available from Allessa GmbH,
phenylpyridines, tolylpyridines, diphenylpyridines, dipyridylbenzenes, dipyridinetoluenes,
and the partially or completely hydrogenated homologs thereof,
and mixtures of two or more of them, in any proportions, to mention only the main organic liquids known and usable in the context of the present invention.

As indicated previously, the present invention relates to a process for producing hydrogen from a liquid capable of being used in at least one hydrogenation/dehydrogenation cycle, said process comprising at least one step wherein said liquid is stripped of the impurities generated during said hydrogenation/dehydrogenation cycle by contacting with a filtering agent.

It has in fact been observed that the successive cycles of hydrogenation and dehydrogenation of LOHC liquids employed for the production of hydrogen often lead to a greater or lesser degradation of said LOHC liquids, this degradation being manifested for example by the formation undesirable by-products, some of which may migrate into the gas phase of the hydrogen formed.

The prior art thus proposes to purify the hydrogen formed during the dehydrogenation of the LOHC liquids. These hydrogen purification operations do generate additional safety constraints, which admittedly can be controlled, but require additional equipment. Furthermore, not all the by-products resulting from the decomposition of the LOHC liquids may migrate into the gaseous phase (hydrogen) but remain in the liquid phase (LOHC liquids) and thus significantly reduce the amount of effective LOHC liquid for the successive hydrogenation and dehydrogenation cycles, and thereby the yield of hydrogen production from the LOHC liquid.

It is therefore important to carry out the purification of the LOHC liquid. The process of the present invention is therefore not a process for purifying the hydrogen produced by dehydrogenation of the LOHC liquid, but a process for producing high purity hydrogen by bringing the LOHC liquid involved in the hydrogenation and dehydrogenation cycles into contact with a filtering agent. According to the invention, this operation of contacting with the filtering agent can be carried out one or more times, repetitively or non-repetitively, preferably repetitively.

The operation for bringing the LOHC liquid into contact with the filtering agent can be carried out as many times as is this necessary and after a number of dehydrogenation and/or hydrogenation operations ranging from 1 to 5000, preferably from 2 to 5000, preferably from 3 to 5000, more preferably from 4 to 5000, preferably from 5 to 5000, advantageously from 10 to 5000, preferably from 10 to 4000, preferably from 10 to 3000, more preferably from 10 to 2000, preferably from 10 to 1000, and very particularly from 10 to 100.

It is also possible to envisage, as a variant of the process of the present invention, the external supply of an amount of LOHC liquid, depending on the amount of LOHC liquid degraded in the abovementioned hydrogenation/dehydrogenation and/or purification operations. The hydrogen production process according to the present invention may also comprise one or more steps, well known to those skilled in the art, of purifying the hydrogen produced by dehydrogenation of the LOHC liquid.

The contacting of the LOHC liquid with the porous filtering agent can be carried out according to any method well known to those skilled in the art, continuously or in batch mode, and for example by passage, either forced (pumps) or by gravity, of the liquid through said filtering agent, such as in a packed column, or else by simple contact in a reactor, such as a reactor optionally equipped with a stirring system, and the like.

The contacting time may vary to a large extent, in particular depending on the nature and the amount of the impurities to be removed, on the nature and the amount of the porous filtering agent used, on the nature and the amount of liquid to be purified, and on the type of contacting system used. In addition, the contacting time varies as a function of the temperature and pressure which are applied.

The temperature at which the liquid is brought into contact with the porous filtering agent is generally between 0° C. and 100° C., preferably between 5° C. and 80° C., more preferably between 10° C. and 50° C. For obvious reasons of simplicity of implementation and economy of the process, the contacting is advantageously carried out without external supply of heating or cooling, for example in a range between 15° C. and 35° C.

The pressure at which the liquid is brought into contact with the porous filtering agent is generally atmospheric pressure or even under slight overpressure or vacuum. For obvious reasons of simplicity of implementation and economy of the process, the contacting is advantageously carried out under atmospheric pressure, or even slight overpressure, in particular overpressure resulting from the circulation of the liquid through said filtering medium. The contacting step can be carried out in air, or in the absence of air or under an inert atmosphere (for example nitrogen, argon, and the like).

According to the invention, the treatment of the liquid can be carried out either before the step of hydrogenating the liquid, or before the dehydrogenation step (actual hydrogen production step) or else before the step of hydrogenating the liquid and before the dehydrogenation step.

It may be advantageous to bring the LOHC organic liquid into contact with the filtering agent before the first use of said organic liquid. In this case, the step of purification by contacting with the filtering agent may advantageously be carried out by the supplier of the LOHC organic liquid. In addition, it may be envisaged to carry out several hydrogenation/dehydrogenation cycles (and therefore several cycles of hydrogen production from the LOHC liquid) and to carry out an operation for purifying said LOHC liquid using the filtering agent after this series of cycles, for example every 10, 20, 30, 40 or 50 hydrogenation/dehydrogenation cycles.

The invention thus enables not only the production of hydrogen of improved purity but also the possibility of increasing the number of hydrogenation/dehydrogenation cycles that can be carried out with the same LOHC organic liquid, which liquid can thus be recycled owing to the purification steps according to the invention.

Preferably, the step of purifying the organic liquid by contacting with the filtering agent is carried out before the dehydrogenation step. More preferably, the purification of the LOHC organic liquid is carried out before the hydrogenation step and before the dehydrogenation step in order to limit the presence of oxygenated derivatives in the partially to completely hydrogenated organic liquid.

Finally, and according to another aspect, the present invention relates to the use of a filtering agent as defined above for the purification of a liquid capable of being used in at least one hydrogenation/dehydrogenation cycle, as indicated previously.

The invention is now illustrated by means of the following examples.

### EXAMPLES

### Example 1

11 g of a filtering agent and 350 g of LOHC organic liquid are introduced into a vacuum flask. The contacting is carried out for a period of 16 hours with magnetic stirring, under nitrogen.

Tests are carried out with DBT (Jarytherm® DBT sold by the company ARKEMA) as LOHC organic liquid. 0.1% by weight of dicyclohexylmethanol (supplier: Sigma-Aldrich) is added to the DBT, and the combined mixture is brought into contact with a filtering agent. The test is carried out with the following filtering agents:
Micro-sorb® 16/30 LVM attapulgite from BASF, and
Siliporite® MK30B0 molecular sieve (supplier: ARKEMA)

At the end of the contacting under stirring for 16 hours, the mixture is filtered under vacuum on a Büchner funnel in order to retain the solids. The filtered liquid is then analyzed (liquid chromatography). It is observed that the residual dicyclohexylmethanol impurity content is of the order of 0.02% by weight or less, thus demonstrating the effectiveness of the filtering agent for the purification of a fluid capable of being used in at least one hydrogenation/dehydrogenation cycle.

1-8. (canceled)

9. A process for producing hydrogen from a liquid capable of being used in at least one hydrogenation/dehydrogenation cycle, said process comprising at least one step wherein said liquid is brought into contact with a filtering agent.

10. The process as claimed in claim 9, wherein said liquid is an aromatic liquid, optionally at least partially or completely hydrogenated.

11. The process as claimed in claim 9, wherein the filtering agent is chosen from filtering agents comprising one or more compounds chosen from minerals based on silicates, carbonates, coal, and also mixtures of two or more of these minerals in any proportions.

12. The process as claimed in claim 9, wherein the filtering agent is selected from the group consisting of clays, zeolites, diatomaceous earths, ceramics, carbonates, and coal derivatives, and also mixtures of two or more of them, in any proportions.

13. The process as claimed in claim 9, wherein the fluid that can be used in the process of the present invention corresponds to the general formula (1):
(A-X)ₙ-B (1)
wherein:
A and B, which are identical or different, represent, independently of one another, an aromatic ring, optionally completely or partially hydrogenated, optionally comprising at least one heteroatom, and optionally substituted by one or more saturated or partially or completely unsaturated hydrocarbon radicals comprising from 1 to 20 carbon atoms,
X represents a spacer group, chosen from a single bond, an oxygen atom, a sulfur atom, the divalent radical —(CRR′)ₘ—, the divalent radical >C═CRR′, and the divalent radical —NR″—, or else
when n is other than 0 (zero), X forms, with the aromatic rings to which it is attached, a saturated or unsaturated ring comprising from 4 to 10 ring members, among which one or more of them may be a heteroatom selected from the group consisting of oxygen, nitrogen, and sulfur, it being possible for said saturated or unsaturated ring to further be substituted by one or more hydrocarbon chains comprising from 1 to 30 carbon atoms,
R and R′, which are identical or different, are chosen, independently of one another, from hydrogen and a saturated or partially or completely unsaturated hydrocarbon radical comprising from 1 to 6 carbon atoms,
R″ represents a saturated or partially or completely unsaturated hydrocarbon radical comprising from 1 to 6 carbon atoms,
m represents an integer of between 1 and 4, endpoints included, and
n can be equal to 0 or represents an integer equal to 1, 2 or 3, with the restriction that, when n is equal to 0, B is substituted by one or more hydrocarbon radicals, defined above.

14. The process as claimed in claim 9, wherein the fluid that can be used in the process of the present invention is selected from the group consisting of:
benzyltoluene (BT), dibenzyltoluene (DBT), the partially or completely hydrogenated homologs thereof, and also mixtures thereof in any proportions,
diphenylethane (DPE) and isomers thereof,
ditolyl ether (DT), isomers thereof, and mixtures thereof,
phenyl xylyl ethane (PXE), isomers thereof and mixtures thereof,
monoxylylxylenes and dixylylxylenes, isomers thereof and mixtures thereof,
1,2,3,4-tetrahydro-(1-phenylethyl)naphthalene,
diisopropylnaphthalene,
monoisopropylbiphenyl and isomers thereof,
phenylethylphenylethane (PEPE) and isomers thereof,
N-ethylcarbazole,
phenylpyridines, tolylpyridines, diphenylpyridines, dipyridylbenzenes, dipyridinetoluenes,
and the partially or completely hydrogenated homologs thereof,
and mixtures of two or more of them, in any proportions.

15. The method as claimed in claim 9, wherein the step of purifying the organic liquid by contacting with the filtering agent is carried out before the dehydrogenation step.

16. Purification of a liquid capable of being used in at least one hydrogenation/dehydrogenation cycle, in a hydrogen production process as defined in claim 9 comprising using a filtering agent.
